(19) United States
(12) Patent Application Publication
(10) Pub. No.: US 2025/0388350 A1
(43) Pub. Date: Dec. 25, 2025

(54) FUSELAGE SPINE WITH MODULAR SECTIONS AND AERO SHELL

(71) Applicant: AeroVironment, Inc., Arlington, VA (US)

(72) Inventor: William John Nicoloff, Camarillo, CA (US)

(21) Appl. No.: 19/245,040

(22) Filed: Jun. 20, 2025

Related U.S. Application Data
(60) Provisional application No. 63/663,014, filed on Jun. 21, 2024.

(51) Int. Cl. B64U 40/20; B64U 10/25; B64U 20/40; B64U 20/75

(52) U.S. Cl. CPC B64U 40/20; B64U 20/40; B64U 20/75; B64U 10/25

(57) ABSTRACT

Systems, devices, and methods including: a spine spanning from a tail portion to a nose portion of an aircraft, wherein the spine is configured to provide rigidity to the aircraft; and one or more modules configured to be detachably attached to the spine, wherein the one or more modules are configured to be movable on the spine to obtain a desired center of gravity for the aircraft.

### CROSS-REFERENCE TO RELATED APPLICATION

This application claims the priority benefit of U.S. Provisional Patent Application Ser. No. 63/663,014, filed Jun. 21, 2024, which is incorporated herein by reference in its entirety.

### TECHNICAL FIELD

Embodiments relate generally to spine aircraft, and more particularly to modular aircraft.

### BACKGROUND

Aircraft generally need to be sufficiently rigid to remain above aeroelastic resonance, while also being lightweight and capable of performing a variety of flight missions effectively. Despite advances in design, there is still a need to improve flight control, enhance durability, and reduce the cost and complexity of manufacturing.

### SUMMARY

A system embodiment disclosed herein comprises: a spine spanning from a tail portion to a nose portion of an aircraft, wherein the spine is configured to provide rigidity to the aircraft; and one or more modules configured to be detachably attached to the spine, wherein the one or more modules are configured to be movable on the spine to obtain a desired center of gravity for the aircraft.

In another embodiment, the system may further comprise: one or more spines spanning from the tail portion to the nose portion of the aircraft, wherein the two or more spines may be configured to be located at both sides of the aircraft.

In another embodiment, a position of each module of the one or more modules may be configured to be movable on the spine to obtain a desired center of gravity for the aircraft.

In another embodiment, the system may further comprise: an active slid, wherein the active slid may be configured to receive a module arrangement instruction, wherein the active slid may be configured to automatically move each module of the one or more modules along the spine based on the received module arrangement instruction.

In another embodiment, the system may further comprise: a computing device including a processor, wherein the processor may be configured to receive weight information of each module of the one or more modules; and wherein the processor may be configured to generate the module arrangement instruction by calculating positions of the one or more modules to have a desired center of gravity for the aircraft based on the weight information.

In another embodiment, the one or more modules may include the computing device.

In another embodiment, wherein the one or more modules may be configured to be detachably attached to the spine using at least one of: a sliding mechanism, an interlocking mechanism, screws, clamps, glue, and adhesive.

In another embodiment, the system may further comprise: a shell configured to cover the one or more modules, wherein the shell may be configured to provide access to the one or more modules disposed within the shell.

In another embodiment, the rigidity of the shell may be less than the rigidity of the spine.

In another embodiment, the shell may comprise a releasable closure mechanism, the releasable closure mechanism comprising: an opening configured to be formed in a line shape along at least a portion of the shell; and a closure configured to be formed along the opening, the closure configured to close the opening; and wherein the releasable closure mechanism may be configured to provide access to the one or more modules disposed within the shell.

In another embodiment, the releasable closure mechanism may comprise at least one of: a zipper and a hook and loop fastener.

In another embodiment, the zipper may be configured to be formed along a longitudinal direction of the shell.

In another embodiment, the nose portion of the aircraft may be configured to receive a first end of the shell; and wherein a rear portion of the aircraft may be configured to receive a second end of the shell, wherein the first end may be distal from the second end.

In another embodiment, positions of the one or more modules may be configured to be adjusted based on different desired flight missions for the aircraft.

In another embodiment, the one or more modules may include at least one of: a payload module, a power source module, a motor controller module, an avionics module, and a computing module.

A method embodiment disclosed herein comprises: determining one or more modules needed for a flight plan of an aircraft; detachably attaching the one or more modules to a spine of the aircraft; and adjusting positions of the one or more modules to obtain a desired center of gravity for the aircraft.

In another embodiment, adjusting the positions of the one or more modules may comprise: receiving, by a processor in communication with the one or more modules and an active slid, weight information of each module of the one or more modules; generating, by the processor, a module arrangement instruction by calculating positions of the one or more modules to have the desired center of gravity based on the weight information; receiving, by the active slid, the module arrangement instruction from the processor; and automatically moving, by the active slid, each module of the one or more modules along the spine based on the received module arrangement instruction.

In another embodiment, adjusting positions of the one or more modules may be configured to be performed for flight conditions, and wherein adjusting positions of the one or more modules may be configured to be performed while the aircraft is in operation.

A method embodiment disclosed herein comprises: securing at least one of: a power source and a payload to a spine of an aircraft; positioning a shell over the at least one of: the power source and the payload; and closing the shell to secure the shell between a nose portion and a rear portion of the aircraft.

In another embodiment, closing the shell may be configured to be performed by closing a releasable closure mechanism, and wherein the releasable closure mechanism may comprise at least one of: a zipper and a hook and loop fastener.

### BRIEF DESCRIPTION OF THE DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1A depicts a bottom perspective view of a system for an aircraft with a spine fuselage and one or more modules attached to the spine, according to one embodiment;

FIG. 1B depicts a schematic bottom view of a system for an aircraft with a spine fuselage and one or more modules attached to the spine, according to one embodiment;

FIG. 1C depicts a schematic bottom view of a system for an aircraft with a spine fuselage and one or more modules attached to the spine, according to another embodiment;

FIG. 2 depicts a top perspective view of the system of FIG. 1A, according to one embodiment;

FIG. 3A depicts a bottom perspective view of the system of FIG. 1A showing the modules attached to the spine, according to one embodiment;

FIG. 3B depicts a side perspective view of the system of FIG. 1A, showing the modules attached to the spine, according to one embodiment;

FIG. 3C depicts a schematic block diagram of the system for an aircraft, according to one embodiment;

FIG. 3D depicts a schematic diagram of the system for an aircraft, according to another embodiment;

FIG. 4A depicts a high-level flowchart of a method for attaching modules to an aircraft and balancing the aircraft, according to one embodiment;

FIG. 4B depicts a high-level flowchart of a method for adjusting positions of one or more modules, according to one embodiment;

FIG. 5A depicts a top perspective view of a shell for an aircraft, according to one embodiment;

FIG. 5B depicts a bottom perspective view of a shell for an aircraft, according to one embodiment;

FIG. 5C depicts a perspective view of a shell for an aircraft, according to one embodiment;

FIG. 6 depicts a side perspective view of a nose portion of the aircraft of FIG. 5A for receiving the shell, according to one embodiment;

FIG. 7 depicts a side perspective view of a propulsion portion, or rear portion of the aircraft of FIG. 5A for receiving the shell, according to one embodiment;

FIG. 8 depicts high-level flowchart of a method for attaching a shell to an aircraft, according to one embodiment;

FIG. 9 illustrates an example top-level functional block diagram of a computing device embodiment;

FIG. 10 shows a high-level block diagram and process of a computing system for implementing an embodiment of the system and process;

FIG. 11 shows a block diagram and process of an exemplary system in which an embodiment may be implemented; and

FIG. 12 depicts a cloud computing environment for implementing an embodiment of the system and process disclosed herein.

### DETAILED DESCRIPTION

The disclosed system and method provide options for adjusting the number and position of modules based on different desired flight missions for an aircraft. A shell with a releasable closure mechanism may provide quick access to these modules to allow the aircraft to be assembled prior to use so that batteries and payloads may be stored separately from the rest of the aircraft until needed for flight.

Aircraft generally need to be sufficiently rigid to stay above aero-elastic resonance. The disclosed system and method use a rigid tubular back bone so that the wings, payload, batteries, avionics, propulsion, and tail are adequately constrained allowing for an open architecture.

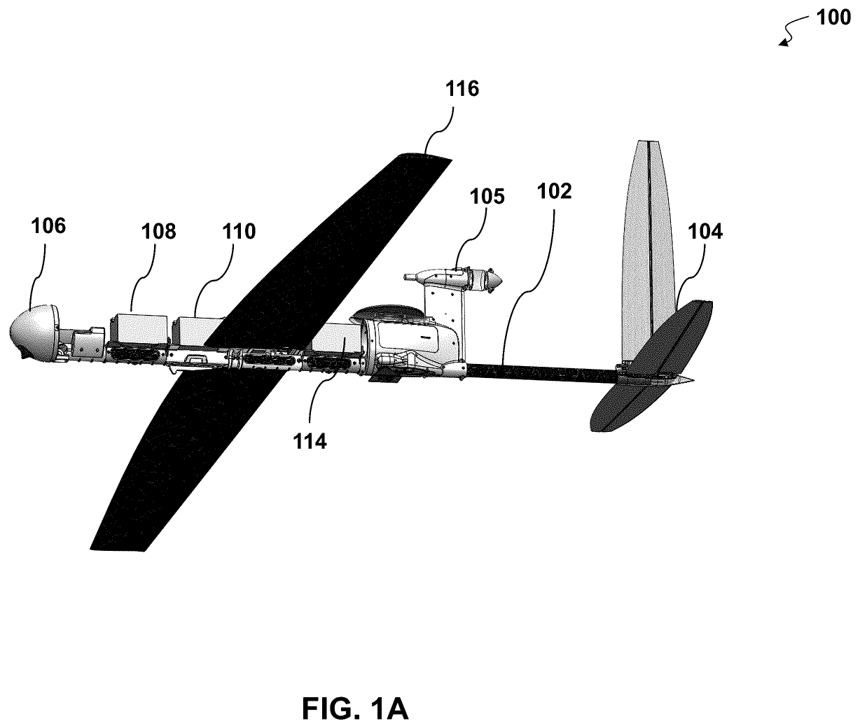

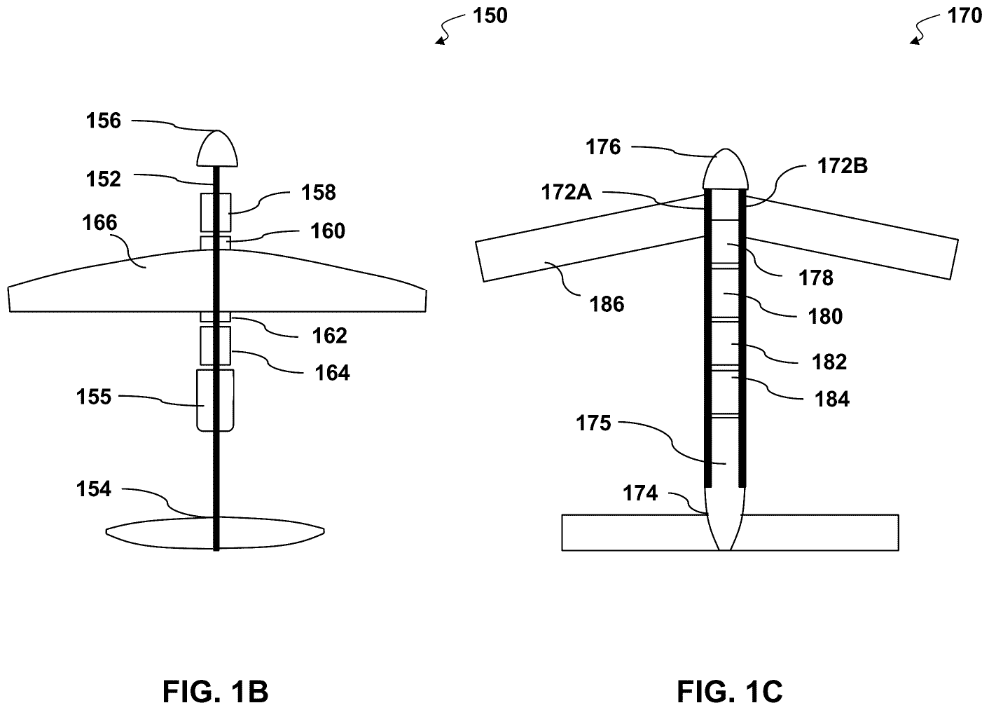

FIG. 1A depicts a bottom perspective view of a system for an aircraft 100 with a spine fuselage and one or more modular sections attached to the spine. With reference to FIG. 1A, the aircraft 100 may include: a spine 102 spanning from a tail portion 104 to a nose portion 106 of the aircraft 100; one or more modules 108, 110, 114 configured to be detachably attached to the spine 102; and wings 116 configured to be attached to a portion of the spine 102. In some embodiments, the aircraft 100 may further include a shell (not shown in FIG. 1A) configured to cover the one or more modules 108, 110, 114.

The spine 102 may be located at the bottom of the aircraft 100, spanning from the tail portion 104 to the nose portion 106. The spine 102 may be configured to serve as a core or backbone, creating a rigid structural frame for the aircraft 100. The durability and structural rigidity of the spine 102 may enable other components, including the one or more modules 108, 110, 114, the wings 116, the nose portion 106, a propulsion portion 105, the tail portion 104, and a shell, attached to the spine 102 to remain stable and securely positioned during the flight of the aircraft 100. The spine 102 may be made of carbon fiber in some embodiments. In other embodiments, the spine 102 may be made from aluminum or any other material that allows for sufficient rigidity. For the desired stiffness to weight ratio, carbon may be one of the better available options while not being too expensive. In some embodiments, there may be one or more spines in the design. In some embodiments, there may be two or more spines to provide additional rigidity.

Some aircraft are designed with a fuselage that may be monocoque and/or a welded frame. A monocoque (single shell) fuselage relies largely on the strength of the skin or covering to carry the primary loads. On the other hand, the disclosed aircraft may use a spine on the bottom spanning from the tail to nose to create a rigid structure to keep the elasticity down. As a result of this design, the control surfaces and other parts of the aircraft does not resonate during flight of the aircraft.

The one or more modules 108, 110, 114 may be positioned along the longitudinal direction of the spine 102 and detachably attached onto the spine 102. Accordingly, the number and position of one or more modules 108, 110, 114 may be adjusted based on different desired flight missions for the aircraft 100. Specifically, the position of each module of the one or more modules 108, 110, 114 may be configured to be movable on the spine 102 to obtain a desired center of gravity for the aircraft 100.

FIG. 1B depicts a schematic bottom view of a system for an aircraft 150 with a spine fuselage and one or more modules attached to the spine. The aircraft 150 may include a similar structure to the aircraft shown in FIG. 1A. With reference to FIG. 1B, the aircraft 150 may include: a single spine 152 spanning from a tail portion 154 to a nose portion 156; one or more modules 158, 160, 162, 164 configured to be detachably attached to the spine 152; and wings 166 configured to be attached to a portion of the spine 152. In some embodiments, the aircraft 150 may further include a shell (not shown in FIG. 1B) configured to cover the one or more modules 158, 160, 162, 164.

FIG. 1C depicts a schematic bottom view of a system for an aircraft 170 with a spine fuselage and one or more modules attached to the spine. Although FIGS. 1A and 1B illustrate that the aircrafts 100, 150 include a single spine, the present system is not limited thereto. With reference to FIG. 1C, the aircraft 170 may include more than one spine 172A, 172B. In some embodiments, two spines 172A, 172B may span in parallel from the tail portion 174, or a propulsion portion 175, to the nose portion 176, and other components, including the one or more modules 178, 180, 182, 184, the wings 186, the nose portion 176, the propulsion portion 175, the tail portion 174, and a shell, may be attached to these multiple spines 172A, 172B. In some embodiments, the two spines 172A, 172B may be located in parallel at both sides of the aircraft 170, spanning from the tail portion 174 to the nose portion 176.

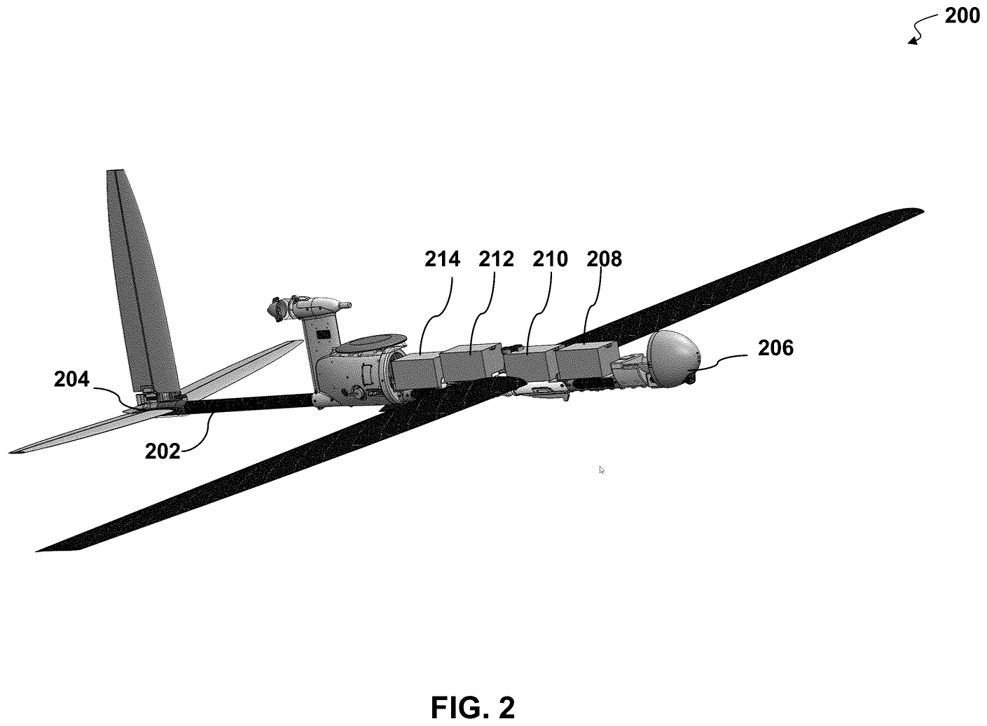

FIG. 2 depicts a top perspective view of the system of FIG. 1A. With reference to FIG. 2, the disclosed aircraft 200 for the system may include a plurality of module 208, 210, 212, 214. The plurality of the modules 208, 210, 212, 214 may be arranged one after another along the longitudinal direction of the spine 202, and each module may be slid on, clicked on, and/or otherwise detachably attached to the top portion of the backbone spine 202. FIG. 2 illustrates that four modules 208, 210, 212, 214 are mounted on the spine 202, but the present system is not limited thereto. The number of modules may be adjusted based on different desired flight missions. For example, the aircraft 200 may include one, two, three, or more than four modules. The position of modules may also be adjusted based on different desired flight missions. For example, one or more modules may be positioned near the nose portion 206 or the tail portion 204, or distributed along the spine 202. In some embodiments, the distance between one pair of adjacent modules may be different from another pair of adjacent modules. The modules 208, 210, 212, 214 may include at least one of: a payload module, a power source module (e.g., battery module), an avionics module, a computing module, a motor controller module, and the like. Each module may be manufactured by 3D printing or lower cost injection.

Different flight plans may necessitate the changing of modules on the aircraft. For example, the aircraft may need to go a particular distance and so only one battery pack may be needed, and a second battery pack may be removed from the aircraft. The disclosed system and method herein may then be used to balance the remaining modules in the aircraft.

In some embodiments, each battery module may contain two connectors. One connector may be a power connector, another connector may be a charging balancing circuit. The connectors may be a part of a cable harness. These connectors allow for a charge and balance of the batteries. In some embodiments, the aircraft 200 may have a bus along the whole length of the fuselage and all of the modules may be plugged into this bus. In some embodiments, the bus may be located proximate the spine 202 or a shell along the spine 202 and connected to each module. Utilizing two connectors for the battery module as part of a harness may reduce cost and/or weight. Additionally, the battery harness may be easily moved as needed to fit other components and/or modules in the aircraft.

In the middle of a military environment where there are explosives and batteries, it is not desired to keep the explosives and batteries together during storage and transportation. The disclosed system and method provide a way to install the batteries and the warhead right before they are needed. It also allows for the maintenance and storage of batteries outside the vehicle and away from sensitive components. Accordingly, the disclosed system and method provide a novel way to quickly and simply access the inner components of the aircraft.

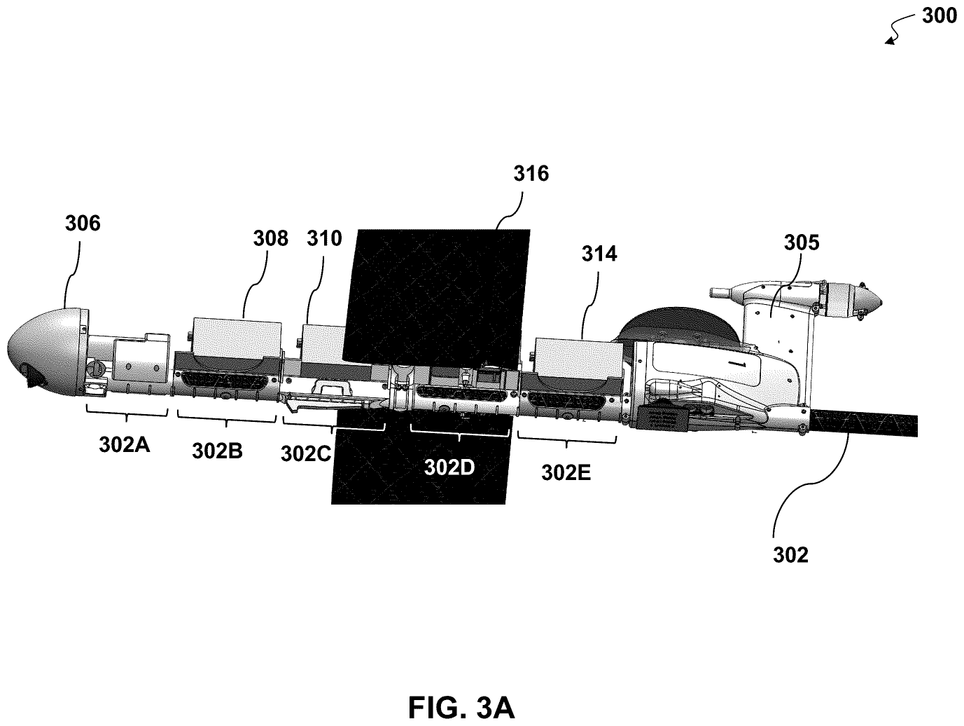

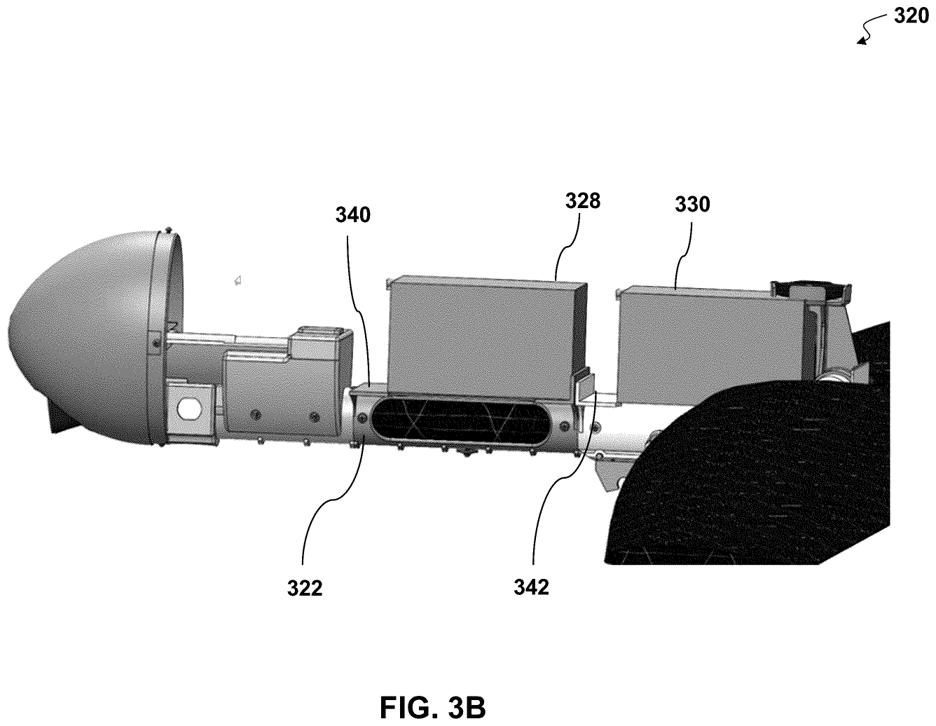

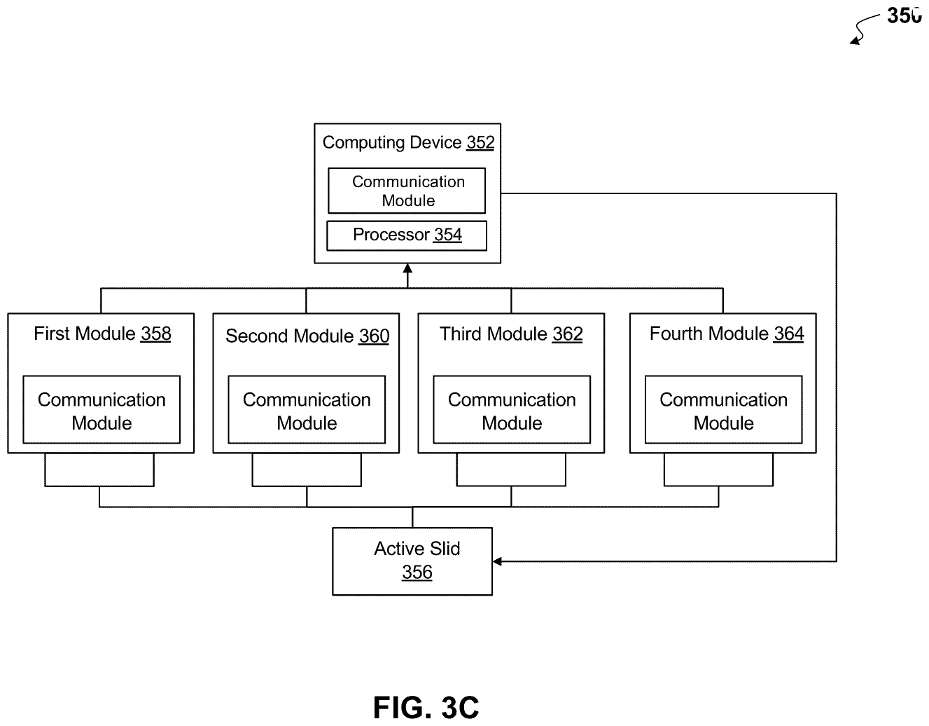

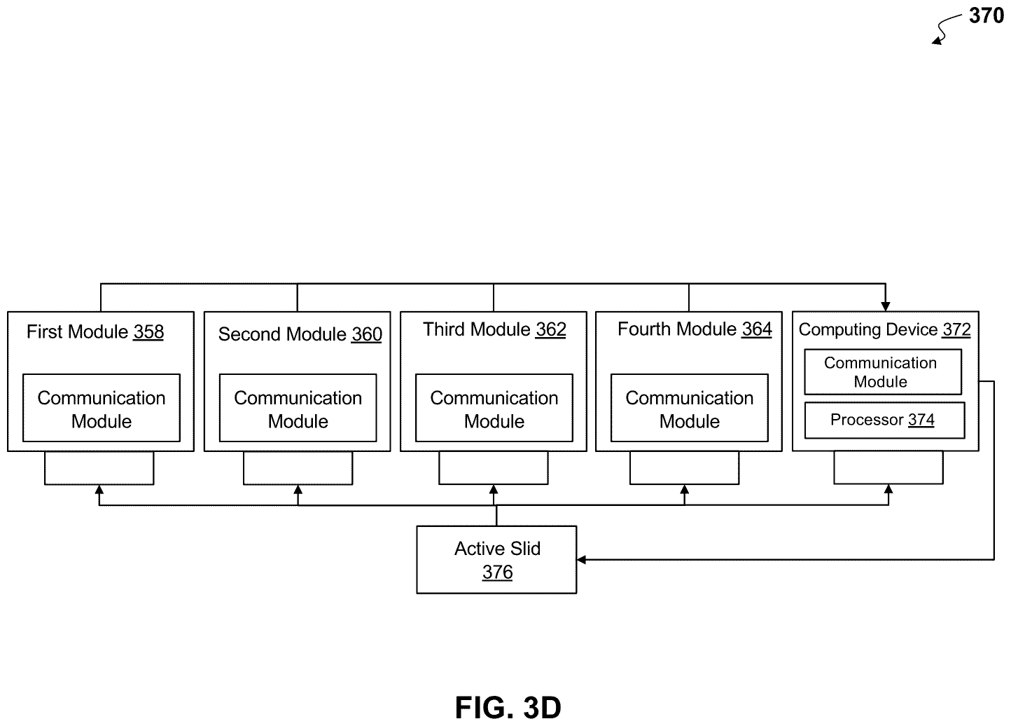

FIG. 3A depicts a bottom perspective view of the system of FIG. 1A. With reference to FIG. 3A, a spine 302 may include multiple modular sections 302A, 302B, 303C, 303D, 304E to which one or more modules 308, 310, 314 may be detachably attached. That is, the modules 308, 310, 314 on the spine 302 may be detached and moved to other position or interchanged with another module. In some embodiments, each module may be moved forward or aft along the spine 302. For example, the motor module may be slid as far back as desired while the nose module may be slid way forward. The system and method disclosed herein allows for easy movement of the modules 308, 310, 314 to obtain a desired center of gravity for the aircraft. The modules 308, 310, 314 may be slid around to a desired center of gravity and then each of the modules may be secured in these desired positions by, for example, screwing down the modules into the spine. In some embodiments, the modules 308, 310, 314 may be moved along the spine 302 via a sliding mechanism (e.g., a servomechanism such as a worm gear, sliding rails with locks, T-slot sliding) configured to allow the modules 308, 310, 314 to be slid on the spine 302 but is not limited thereto.

Once the positions of modules 308, 310, 314 are determined, the modules 308, 310, 314 may be secured to the spine 302 with at least one of: a sliding mechanism (e.g., sliding rails with locks, T-slot sliding), an interlocking mechanism (e.g., stud-and-tube interlock, snap-fit, interference fit, latch and catch, push-to-lock, spring-loaded pin), screws, clamps, glue, adhesive, or the like. In some embodiments, the modules 308, 310, 314 may attach to the spine 302 by slightly sliding the modules 308, 310, 314 over the spine 302 using the sliding mechanism. In other embodiments, the modules 308, 310, 314 may click on to the spine 302 using the interlocking mechanism. In some embodiments, the modules 308, 310, 314 may be secured to the spine 302, such as by a single screw. The screw may go through the module and into the spine 302. In some embodiments, the modules 308, 310, 314 may be secured to the spine 302 with a clamp where the clamp grabs tight against the spine 302 when tightened.

In some embodiments, the multiple modules 308, 310, 314 may be arranged one after another along the longitudinal direction of the spine 302, and each module may click together, where each one of these modules 308, 310, 314 may click into the adjacent module in front and behind it, as applicable. In some embodiments, a screw may be used to secure the very first module and the very back module. In other embodiments, a screw may be used in each module to ensure the modules do not rotate or move.

The aircraft 300 may include a spot in front of the wing that corresponds to a center of gravity and may be placed on or supported at this point on a balance/holding fixture during storage, transport, or maintenance. For this use, the modules may be slid/moved around until the aircraft obtains a center of gravity at this spot, e.g., by making the aircraft balanced, level, and/or substantially level when balanced at this spot. Substantially level may mean that the aircraft is able to balance at this balance/holding point without tipping forward or backward.

In some embodiments, the multiple modules 308, 310, 314 may have different weights, which may impact the balance of the aircraft 300. Accordingly, by adjusting the positions of the multiple modules 308, 310, 314, the aircraft 300 may obtain a desired balance. For example, some modules 308, 310, 314 may have variable weights, such as a fuel tank instead of a battery. In these embodiments, the module positions may be adjusted based on a measured and/or expected change in weight so as to maintain a desired center of gravity for the aircraft while the aircraft is in flight. In some embodiments, a desired balance may be achieved by swapping positions of the modules relative to one another. For example, the positions of the wing payload and the battery payloads may be interchanged to move the center of gravity of the aircraft.

To adjust the center of gravity, other components on the aircraft 300, other than the modules 308, 310, 314, may also be moved to other positions and/or interchanged with another component. In some embodiments, it may be desired to change or swap out a payload. For a lighter payload, the payload may be moved forward relative to the nose portion 306 and the wings 316. In other embodiments, weight may be added to certain portions of the aircraft 300 to balance the aircraft weight. In some configurations, the rear pod, or propulsion portion, 305 may move forward and aft based upon the different configurations desired. In some embodiments, the wings 316 may be slid forward and aft along the spine 302 to obtain a desired balance based on the weights and placement of the modules 308, 310, 314 on the spine 302. In some configurations, the wing 316 may move forward and aft if space is available in the module area.

FIG. 3B depicts a side perspective view of the system of FIG. 1A. With reference to FIG. 3B, an aircraft 320 may include multiple mounts 340, 342 on a spine 322 to support modules 328, 320, respectively. In some embodiments, each mount of the mounts 340, 342 may include a cylinder-shaped portion surrounding the spine 322 and a plate-shaped portion disposed on the cylinder-shaped portion. In this structure, each module of the multiple modules 328, 320 may be positioned on each mount, respectively.

FIG. 3C depicts a schematic diagram of the system for an aircraft. With reference to FIG. 3C, the aircraft 350 may include: a computing device 352 including a processor 354 and multiple modules 358, 360, 362, 364 configured to communicate with the processor 364 via respective communication module. In some configurations, the modules 358, 360, 362, 364 may communicate their weight to the processor 354 of the aircraft 350 and/or module. This information on weights may be used by the processor 354 to calculate and adjust the number and/or positions of modules 358, 360, 362, 364 to have a desired center of gravity for the aircraft 350 as needed. In some embodiments, this adjustment may be via a user instruction to move a module and/or movement of the module via a servo such as a worm gear.

In some embodiments, a user may weigh each module before adding it to the spine. In other embodiments, the weight may be known for each module. In some embodiments, the payload mass and/or battery mass may be known. The processor 354 of the system 350 may receive the entered weight, calculate a desired arrangement of the modules 358, 360, 362, 364 to have a desired center of gravity for the aircraft 350, and instruct a user as to which way to assemble the modules 358, 360, 362, 364 to the spine. Based on the instruction, a user may loosen a screw securing the modules 358, 360, 362, 364 and then move one or more of the module 358, 360, 362, 364 to adjust its position. In some embodiments, the modules 358, 360, 362, 364 may include a payload module closest to the nose portion, then one or more battery modules, a motor module, and the like.

In some embodiments, the aircraft 350 may further comprise an active slid 356 configured to move each module 358, 360, 362, 364 along a spine based on a module arrangement instruction from the processor 354 or a user. The aircraft 350 may utilize the active slide 356 to adjust the center of gravity automatically. The system may have a spot range in the middle of the spine for the wing module to slide forward and aft. In some embodiments, the system may be automated to adjust the module positions to obtain the desired center of gravity for the aircraft. In some embodiments, each module 358, 360, 362, 364 may detect or obtain its own weight and/or position and transmit the weight and/or position information to the processor 354. The processor 354 may calculate a desired arrangement of the modules 358, 360, 362, 364 based on the received weight and/or position information and transmit the calculated arrangement to the active slide 356 so that adjustments may be automatically made to achieve the desired balance and center of gravity of the aircraft. In some embodiments, the system may include weights on the modules and/or strain gauges on the modules.

In some embodiments, the positions of the modules 358, 360, 362, 364 may be adjusted for flight conditions such as landing as opposed to cruising at level altitude. In some embodiments, when the aircraft 350 is flying at steady level, the arrangement of the modules 358, 360, 362, 364 may be adjusted to shift the center of gravity aft to get a more unstable configuration to obtain higher efficiency for the aircraft 350. In some embodiments, the wing may be moved forward to get a more unstable configuration to get higher efficiency for the aircraft 350. In other embodiments, the position of the wing may be moved forward to deep stall for landing. In other embodiments, the positions of the modules 358, 360, 362, 364 may be adjusted while the aircraft is in operation.

FIG. 3D depicts a schematic diagram of the system for an aircraft 370. With reference to FIG. 3D, the computing device 372 including a processor 374 may be located as one of modules 358, 360, 362, 364, 372 detachably attached to a spine. In some embodiments, the computing device 372 may also be configured to be moved by an active slid 376.

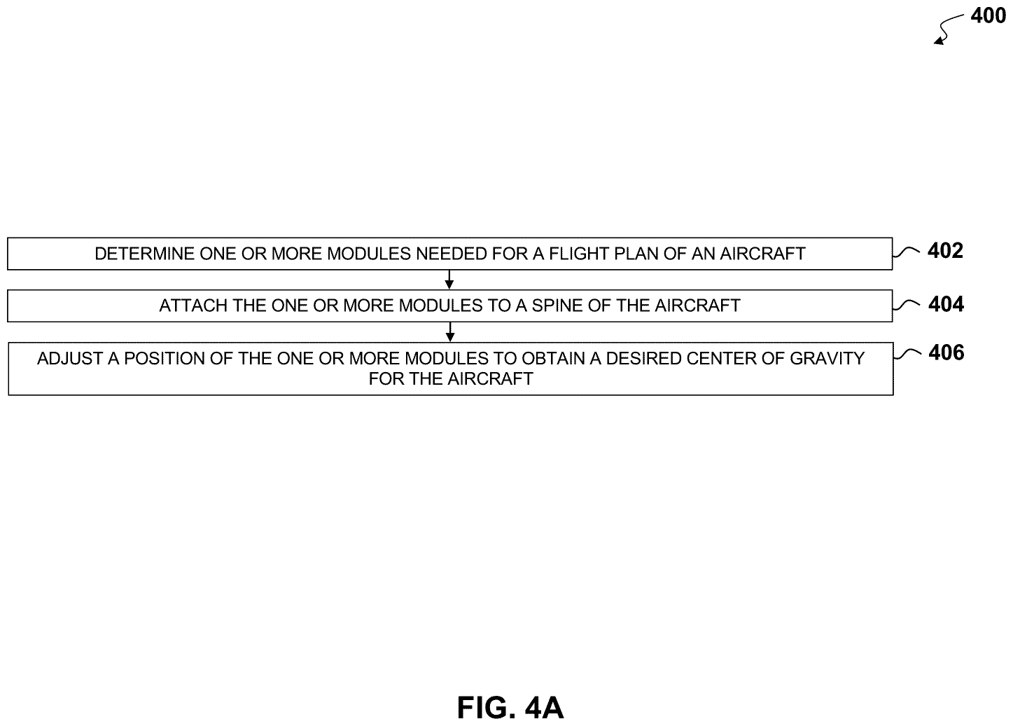

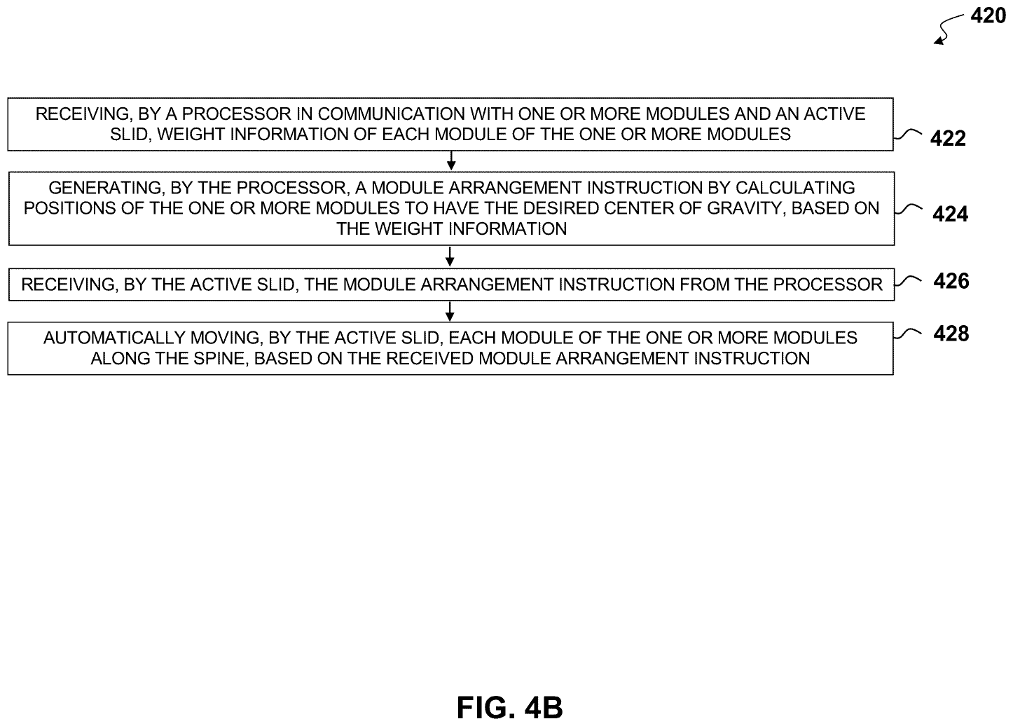

FIG. 4A depicts a high-level flowchart of a method 400 for attaching modular sections to an aircraft and balancing the aircraft. With reference to FIG. 4A, the method 400 may include determining one or more modules needed for a flight plan of an aircraft (step 402). The method 400 may then include attaching the one or more modules to a spine of the aircraft (step 404). The method 400 may then include adjusting a position of the one or more modules to obtain a desired center of gravity for the aircraft (step 406).

The placement and/or balancing of the one or more modules may be adjusted by a user in some embodiments. For example, a user may place the aircraft on a balancing board via a notch on the aircraft and adjust the position of the one or more modules until the aircraft is level and the center of gravity is achieved at the notch of the aircraft.

The placement and/or balancing of the one or more modules may be calculated by a processor of a computing device in the system in some embodiments. For example, a user may add in a flight plan, and the computing device may instruct the user as to which modules to add and where to add them to ensure that the aircraft is balanced and has a desired center of gravity. The computing device may also include adjustments for where to place the modules in their positions, such as further forward or further aft.

FIG. 4B depicts a high-level flowchart of a method 420 for adjusting positions of the one or more modules. With reference to FIG. 4B, the method 420 for adjusting the positions of the one or more modules may comprises: receiving, by a processor in communication with the one or more modules and an active slid, weight information of each module of the one or more modules (step 422); generating, by the processor, a module arrangement instruction by calculating positions of the one or more modules to have the desired center of gravity based on the weight information (step 424); receiving, by the active slid, the module arrangement instruction from the processor (step 426); and automatically moving, by the active slid, each module of the one or more modules along the spine based on the module arrangement instruction (step 428). In some embodiments, the method 420 for adjusting positions of the one or more modules may be performed for flight conditions. In some embodiments, the method 420 for adjusting positions of the one or more modules may be performed while the aircraft is in operation.

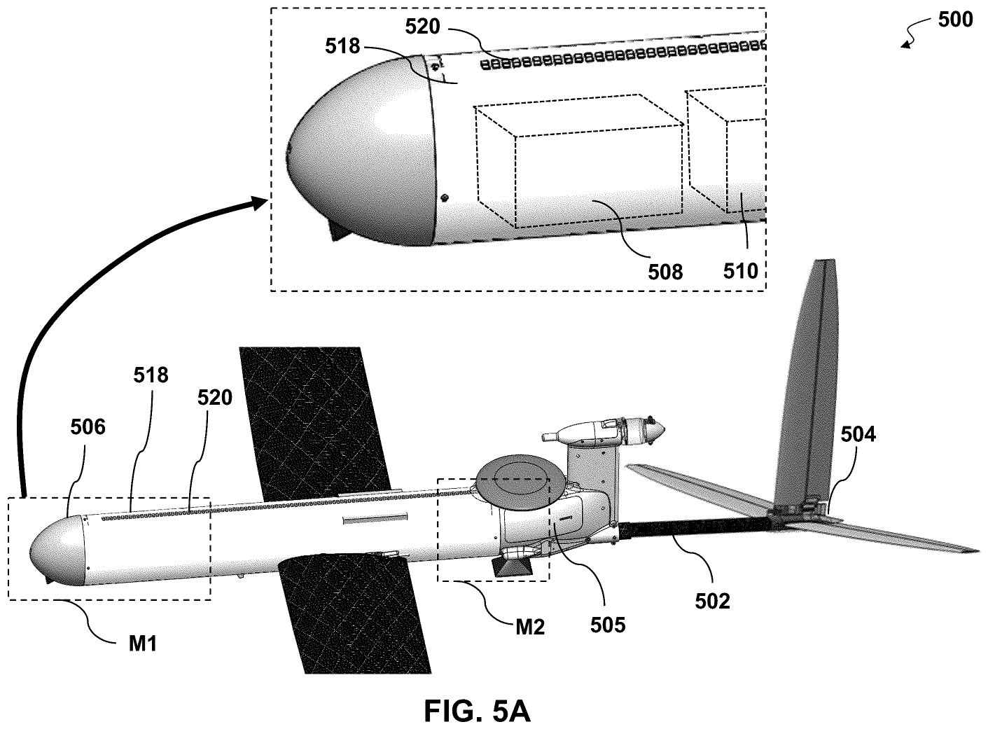

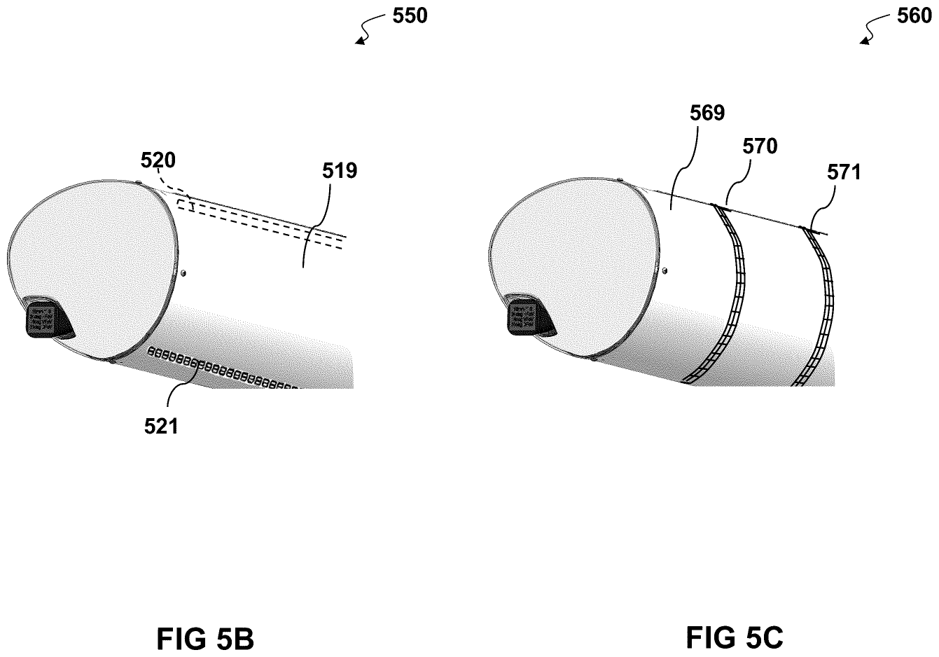

FIG. 5A depicts a top perspective view of a shell for an aircraft 500. FIG. 5B depicts a bottom perspective view of a shell for an aircraft, according to one embodiment. FIG. 5C depicts a perspective view of a shell for an aircraft, according to one embodiment. With reference to FIG. 5A, the aircraft 500 may include a shell 518 configured to cover internal modules 508, 510 between a nose portion 506 and a rear portion 505. The shell 518 may provide access to the one or more modules 508, 510 disposed within the shell 518. Specifically, the shell 518 may comprises a releasable closure mechanism configured to selectively open and close a portion of the shell 518, providing access to the modules 508, 510 disposed within the shell 518. The releasable closure mechanism may include an opening configured to be formed in a line shape, (e.g., seamline cut, slit) along at least a portion of the shell 518 and a closure configured to be formed along the opening to close the opening.

In some embodiments, the releasable closure mechanism may be a zipper 520. In some embodiments, the zipper 520 may be made from plastic so as to not inhibit performance of the GPS on the aircraft. In some embodiments, the zipper 520 may be metal. In some embodiments, there may be two zippers on the shell 518, and the shell 518 may be detached by unzipping both zippers. In some embodiments, as shown in an aircraft 550 of FIG. 5B, two zippers 520, 521 may be located at the top and bottom of a shell 519, respectively but is limited thereto. Multiple zippers may be arranged in any suitable manner. In some embodiments, as shown in an aircraft 560 of FIG. 5C, two or more zippers 570, 571 may be located around a shell 569. In other embodiments, the releasable closure mechanism may be hook and loop fasteners in place of a zipper 520. In some embodiments, the shell may utilize other materials and have a mechanical hinge to open and close the shell around the fuselage of the aircraft.

Unlike some aircraft shells, which usually use more rigid bodies, the shell 518 of the disclosed system may be made from Polyethylene terephthalate glycol (PETG or PET-G) with releasable closure mechanism (e.g., a zipper 520) added to the tube. Polyethylene terephthalate (PET) is a thermoplastic polyester that provides significant chemical resistance, durability, and excellent formability for manufacturing. PETG may be used for shipping tubes. In some embodiments, the rigidity of the shell 518 may be less than the rigidity of the spine 502. While the spine 502 is configured to provide a structural rigidity to the aircraft, the shell 518 may include a semi-rigid tube to allow for light weight easy access to the modular elements 508, 510 of the aircraft. The tube may be made from plastic, rigidized cloth, foam, or the like. The torsional rigidity may be provided by this tube alone. Meanwhile, the tube of the shell 518 that forms the fuselage of the aircraft 500 may be still semi rigid. Specifically, the tube may be rigid enough that it does not flap in the wind based upon an expected velocity. For embodiments where the speed of the aircraft is slow, a lower rigidity material may be used. In embodiments with a slow aircraft speed, a tube made from a heavy canvas material may work. In some embodiments, each of the spine 502 and the shell 518 may include a semi-rigid material.

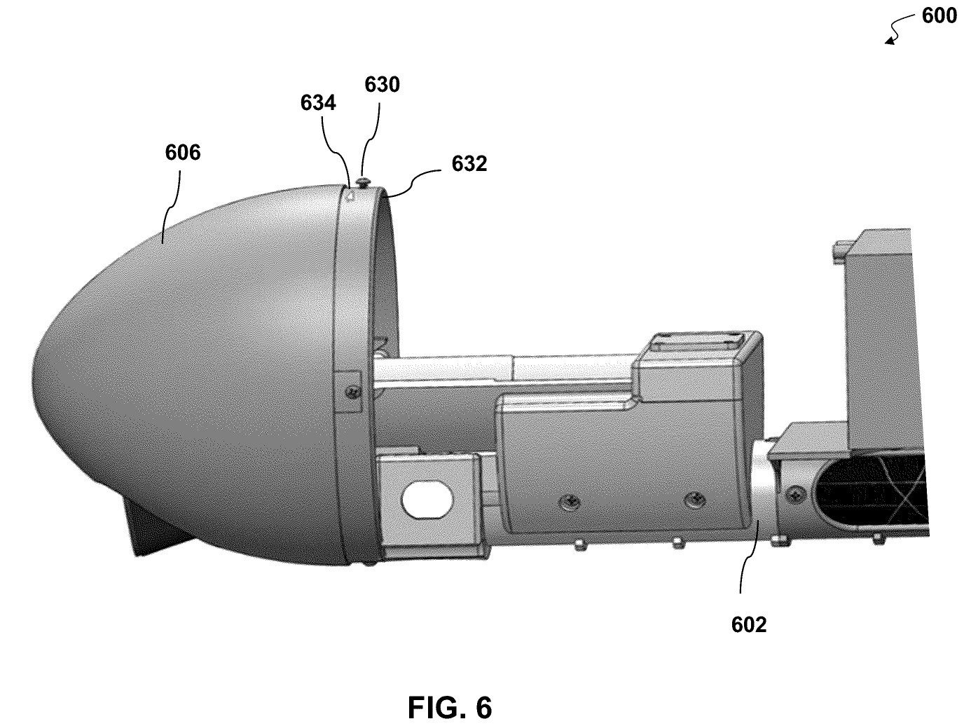

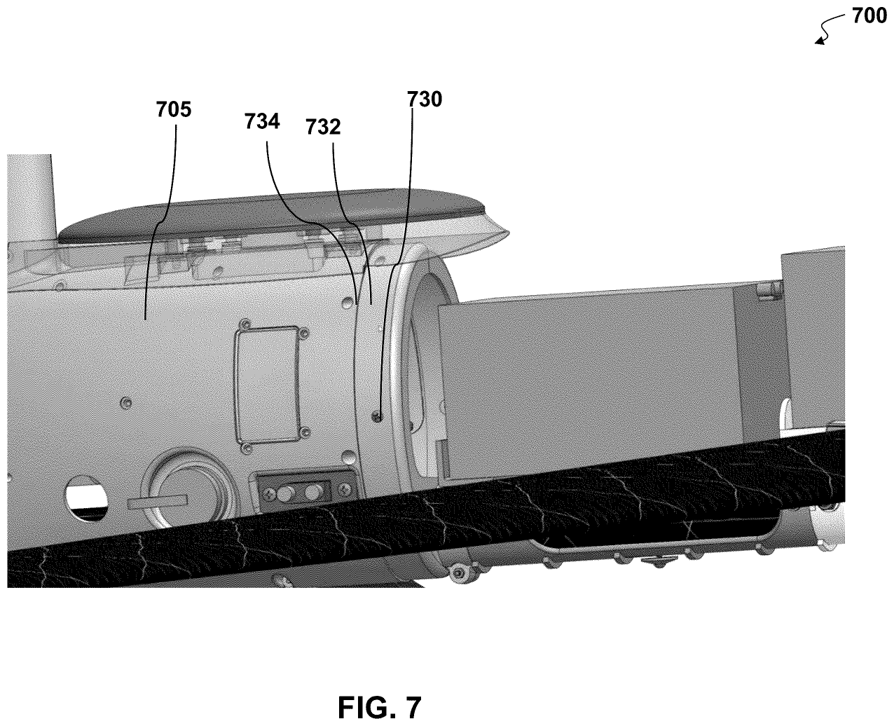

FIG. 6 depicts a side perspective view of a nose portion of the aircraft of FIG. 5A for receiving the shell. The FIG. 6 may be a magnified view corresponding to a portion M1 of FIG. 5A, shown in a state where the shell (518, FIG. 5A) has been removed. FIG. 7 depicts a side perspective view of a rear portion of the aircraft of FIG. 5A for receiving the shell. The FIG. 7 may be a magnified view corresponding to a portion M2 of FIG. 5A, shown in a state where the shell (518, FIG. 5A) has been removed.

With reference to FIGS. 6 and 7, in some embodiments, there may be one or more screws 630 to secure the shell to the nose portion 606, or front portion. In some embodiments, the shell, or fuselage material, may go over a lip 632 and a recessed edge 634 of the nose portion 606, or front portion, and a lip 732 and a recessed edge 734 of the propulsion portion 706, or rear portion. When the shell is closed by the releasable closure mechanism, such as by zipper, hook and loop fastener, or other fastener, the shell sits on the lip 632 and recessed edge 634 of the nose portion 606 and the lip 732 and recessed edge 734 of the propulsion portion 706, between the two ends. In some embodiments, the lip 632 and recessed edge 634 of the end of the nose portion 606 may be an area that has a lesser radius than the rest of the nose portion 606, and the lip 732 and recessed edge 734 of the propulsion portion, or rear portion, 705 may be an area that has a lesser radius than the rest of the rear portion 705.

In some embodiments, it may lock onto the front with no shell on the front and no shell on the rear. In some embodiments, there may be no shell on the tail portion of the aircraft where there are no modules and/or payload located.

In other embodiments, with a detent and properly sizing this nose shell and this rear shell when the shell is zipped up, the shell may wrap around the modules in a ring shape, and the length of the shell may be butted against a front face of the nose portion 606 and a back face of the propulsion portion 705, respectively, so when zipped up the shell, the shell may be locked between the nose portion 606, or front portion, and the propulsion portion, or rear portion.

In some embodiments, the system 600 may have a slider, such as a worm drive automatic slider that may move the nose portion 606 in and out. In some embodiments, to install or remove the shell, the nose portion 606 may be removable, a wing spar that slides through the wing may be pulled out, and then the entire shell may be attached or removed. Specifically, in a state where the nose portion 606 is removed, the shell may be slid over the assembly including the spine 102 and modules attached to the spine, and the wing spar may be slid through the shell. Then, the nose portion 606 may be reattached, and the aircraft 600 is ready to be launched.

In some embodiments, torsional stability in the fuselage may be provided by one or more nubs to secure the shell to the nose portion and rear portion.

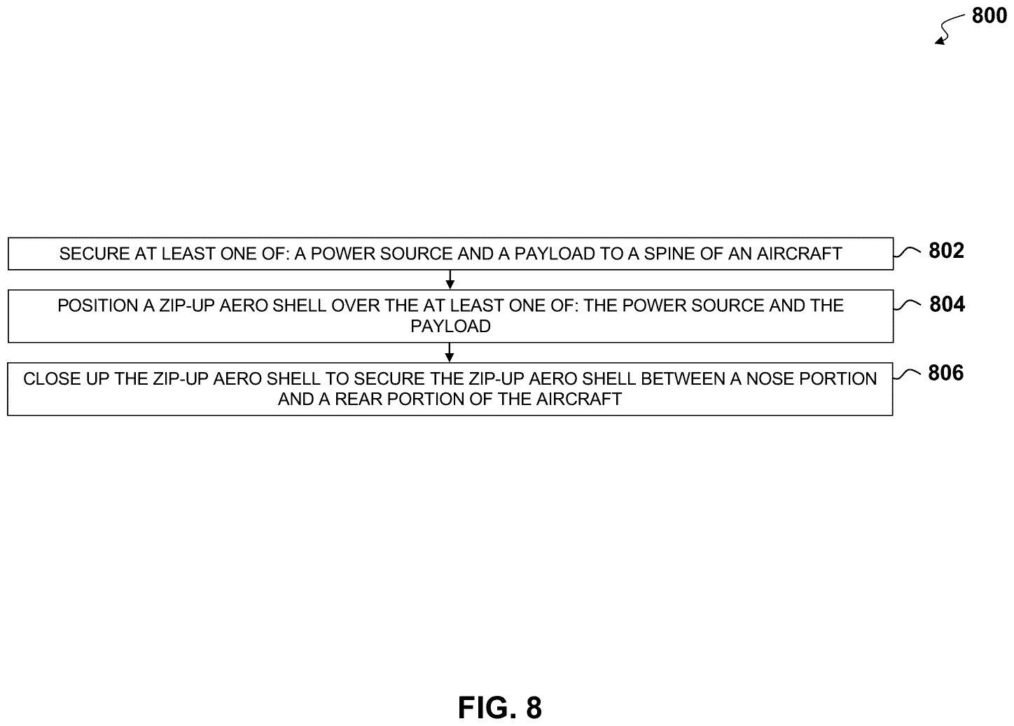

FIG. 8 depicts high-level block diagram of a method 800 for attaching a shell to an aircraft. The method 800 may include securing at least one of: a battery and a payload to a spine of an aircraft (step 802). The method 800 may then include positioning a shell over the at least one of: the battery and the payload (step 804). The method 800 may then including closing up the shell to secure the shell between a nose portion and a rear portion of the aircraft (step 806).

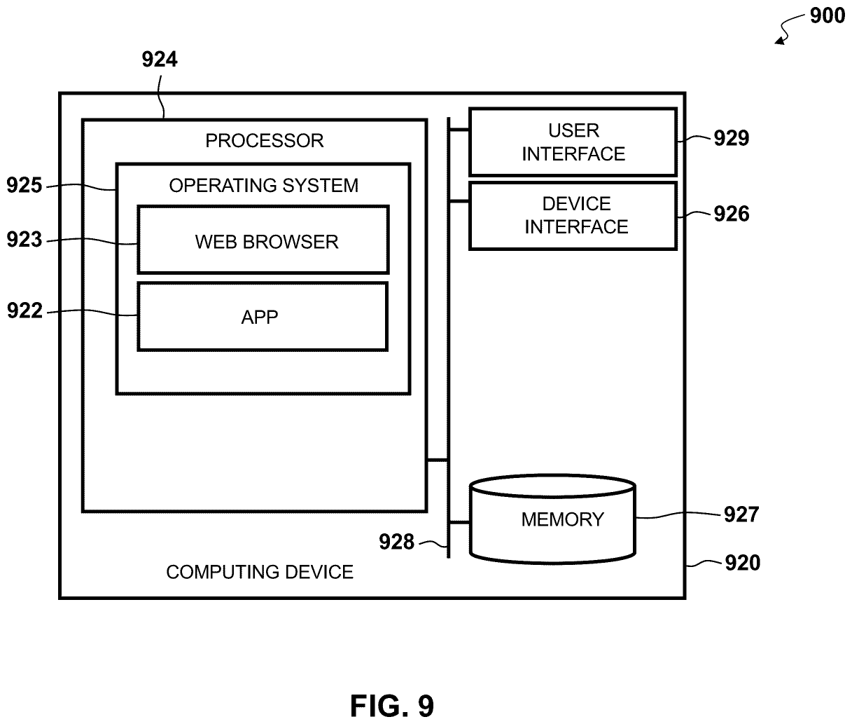

FIG. 9 illustrates an example of a top-level functional block diagram of a computing device embodiment 900. The example operating environment is shown as a computing device 920 comprising a processor 924, such as a central processing unit (CPU), addressable memory 927, an external device interface 926, e.g., an optional universal serial bus port and related processing, and/or an Ethernet port and related processing, and an optional user interface 929, e.g., an array of status lights and one or more toggle switches, and/or a display, and/or a keyboard and/or a pointer-mouse system and/or a touch screen. Optionally, the addressable memory may, for example, be: flash memory, eprom, and/or a disk drive or other hard drive. These elements may be in communication with one another via a data bus 928. In some embodiments, via an operating system 925 such as one supporting a web browser 923 and applications 922, the processor 924 may be configured to execute steps of a process establishing a communication channel and processing according to the embodiments described above.

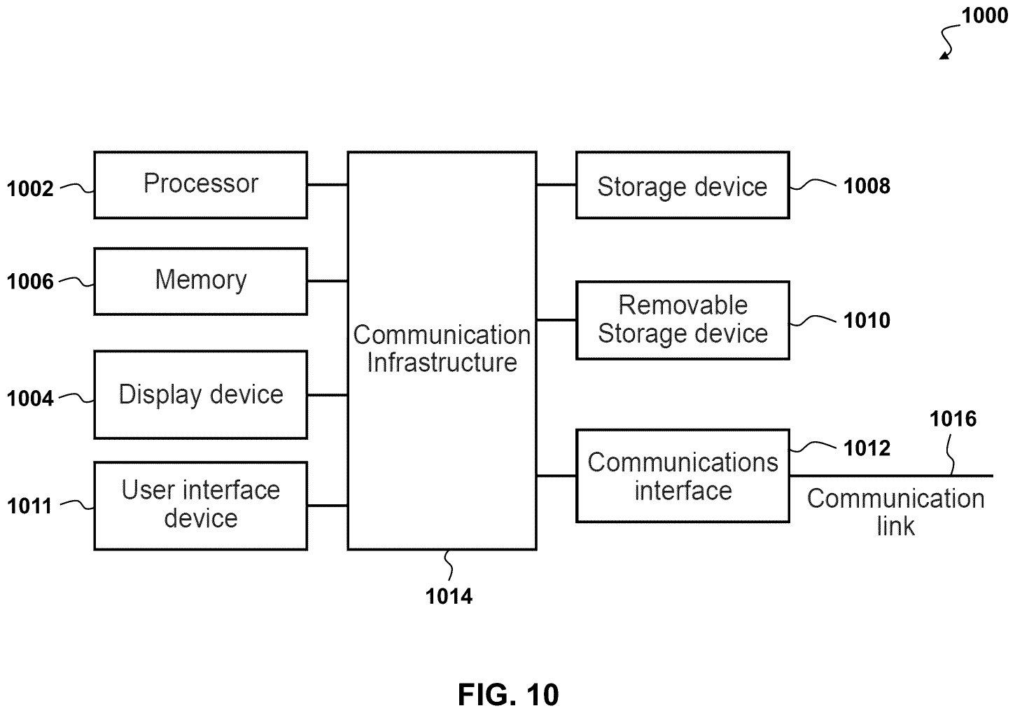

FIG. 10 is a high-level block diagram 1000 showing a computing system comprising a computer system useful for implementing an embodiment of the system and process, disclosed herein. Embodiments of the system may be implemented in different computing environments. The computer system includes one or more processors 1002, and can further include an electronic display device 1004 (e.g., for displaying graphics, text, and other data), a main memory 1006 (e.g., random access memory (RAM)), storage device 1008, a removable storage device 1010 (e.g., removable storage drive, a removable memory module, a magnetic tape drive, an optical disk drive, a computer readable medium having stored therein computer software and/or data), user interface device 1011 (e.g., keyboard, touch screen, keypad, pointing device), and a communication interface 1012 (e.g., modem, a network interface (such as an Ethernet card), a communications port, or a PCMCIA slot and card). The communication interface 1012 allows software and data to be transferred between the computer system and external devices. The system further includes a communications infrastructure 1014 (e.g., a communications bus, cross-over bar, or network) to which the aforementioned devices/modules are connected as shown.

Information transferred via communications interface 1014 may be in the form of signals such as electronic, electromagnetic, optical, or other signals capable of being received by communications interface 1014, via a communication link 1016 that carries signals and may be implemented using wire or cable, fiber optics, a phone line, a cellular/mobile phone link, an radio frequency (RF) link, and/or other communication channels. Computer program instructions representing the block diagram and/or flowcharts herein may be loaded onto a computer, programmable data processing apparatus, or processing devices to cause a series of operations performed thereon to produce a computer implemented process.

Embodiments have been described with reference to flowchart illustrations and/or block diagrams of methods, apparatus (systems) and computer program products according to embodiments. Each block of such illustrations/diagrams, or combinations thereof, can be implemented by computer program instructions. The computer program instructions when provided to a processor produce a machine, such that the instructions, which execute via the processor, create means for implementing the functions/operations specified in the flowchart and/or block diagram. Each block in the flowchart/block diagrams may represent a hardware and/or software module or logic, implementing embodiments. In alternative implementations, the functions noted in the blocks may occur out of the order noted in the figures, concurrently, etc.

Computer programs (i.e., computer control logic) are stored in main memory and/or secondary memory. Computer programs may also be received via a communications interface 1012. Such computer programs, when executed, enable the computer system to perform the features of the embodiments as discussed herein. In particular, the computer programs, when executed, enable the processor and/or multi-core processor to perform the features of the computer system. Such computer programs represent controllers of the computer system.

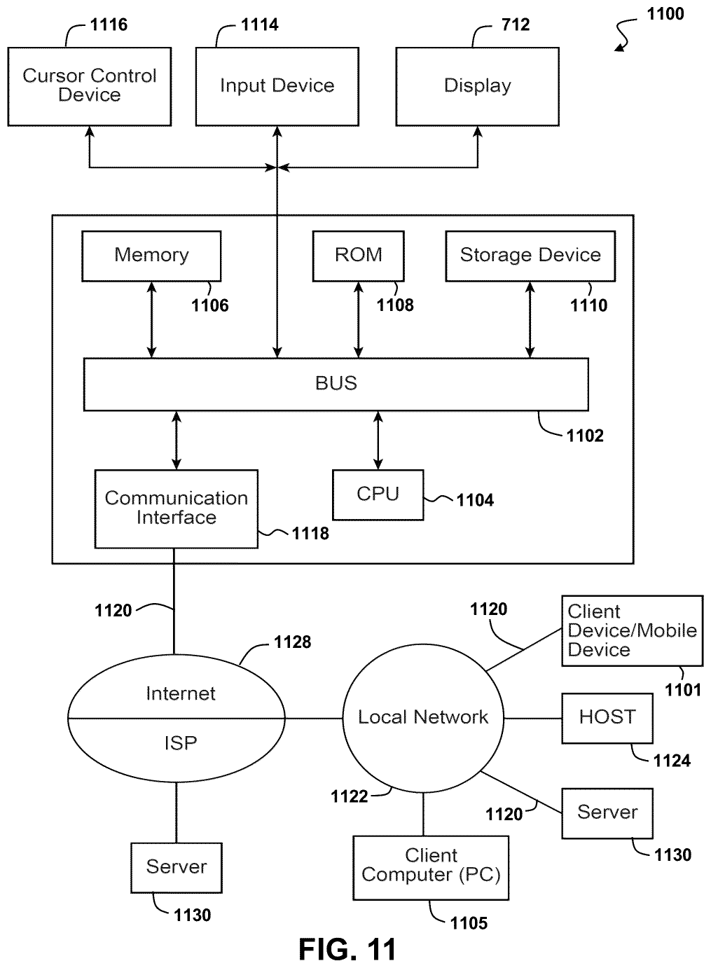

FIG. 11 shows a block diagram of an example system 1100 in which an embodiment may be implemented. The system 1100 includes one or more client devices 1101 such as consumer electronics devices, connected to one or more server computing systems 1130. A server 1130 includes a bus 1102 or other communication mechanism for communicating information, and a processor (CPU) 1104 coupled with the bus 1102 for processing information. The server 1130 also includes a main memory 1106, such as a random access memory (RAM) or other dynamic storage device, coupled to the bus 1102 for storing information and instructions to be executed by the processor 1104. The main memory 1106 also may be used for storing temporary variables or other intermediate information during execution or instructions to be executed by the processor 1104. The server computer system 1130 further includes a read only memory (ROM) 1108 or other static storage device coupled to the bus 1102 for storing static information and instructions for the processor 1104. A storage device 1110, such as a magnetic disk or optical disk, is provided and coupled to the bus 1102 for storing information and instructions. The bus 1102 may contain, for example, thirty-two address lines for addressing video memory or main memory 1106. The bus 1102 can also include, for example, a 32-bit data bus for transferring data between and among the components, such as the CPU 1104, the main memory 1106, video memory and the storage 1110. Alternatively, multiplex data/address lines may be used instead of separate data and address lines.

The server 1130 may be coupled via the bus 1102 to a display 1112 for displaying information to a computer user. An input device 1114, including alphanumeric and other keys, is coupled to the bus 1102 for communicating information and command selections to the processor 1104. Another type or user input device comprises cursor control 1116, such as a mouse, a trackball, or cursor direction keys for communicating direction information and command selections to the processor 1104 and for controlling cursor movement on the display 1112.

According to one embodiment, the functions are performed by the processor 1104 executing one or more sequences of one or more instructions contained in the main memory 1106. Such instructions may be read into the main memory 1106 from another computer-readable medium, such as the storage device 1110. Execution of the sequences of instructions contained in the main memory 1106 causes the processor 1104 to perform the process steps described herein. One or more processors in a multi-processing arrangement may also be employed to execute the sequences of instructions contained in the main memory 1106. In alternative embodiments, hard-wired circuitry may be used in place of or in combination with software instructions to implement the embodiments. Thus, embodiments are not limited to any specific combination of hardware circuitry and software.

The terms “computer program medium,” “computer usable medium,” “computer readable medium”, and “computer program product,” are used to generally refer to media such as main memory, secondary memory, removable storage drive, a hard disk installed in hard disk drive, and signals. These computer program products are means for providing software to the computer system. The computer readable medium allows the computer system to read data, instructions, messages or message packets, and other computer readable information from the computer readable medium. The computer readable medium, for example, may include non-volatile memory, such as a floppy disk, ROM, flash memory, disk drive memory, a CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allow a computer to read such computer readable information. Computer programs (also called computer control logic) are stored in main memory and/or secondary memory. Computer programs may also be received via a communications interface. Such computer programs, when executed, enable the computer system to perform the features of the embodiments as discussed herein. In particular, the computer programs, when executed, enable the processor multi-core processor to perform the features of the computer system. Accordingly, such computer programs represent controllers of the computer system.

Generally, the term “computer-readable medium” as used herein refers to any medium that participated in providing instructions to the processor 1104 for execution. Such a medium may take many forms, including but not limited to, non-volatile media, volatile media, and transmission media. Non-volatile media includes, for example, optical or magnetic disks, such as the storage device 1110. Volatile media includes dynamic memory, such as the main memory 1106. Transmission media includes coaxial cables, copper wire and fiber optics, including the wires that comprise the bus 1102. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read.

Various forms of computer readable media may be involved in carrying one or more sequences of one or more instructions to the processor 1104 for execution. For example, the instructions may initially be carried on a magnetic disk of a remote computer. The remote computer can load the instructions into its dynamic memory and send the instructions over a telephone line using a modem. A modem local to the server 1130 can receive the data on the telephone line and use an infrared transmitter to convert the data to an infrared signal. An infrared detector coupled to the bus 1102 can receive the data carried in the infrared signal and place the data on the bus 1102. The bus 1102 carries the data to the main memory 1106, from which the processor 1104 retrieves and executes the instructions. The instructions received from the main memory 1106 may optionally be stored on the storage device 1110 either before or after execution by the processor 1104.

The server 1130 also includes a communication interface 1118 coupled to the bus 1102. The communication interface 1118 provides a two-way data communication coupling to a network link 1120 that is connected to the world wide packet data communication network now commonly referred to as the Internet 1128. The Internet 1128 uses electrical, electromagnetic or optical signals that carry digital data streams. The signals through the various networks and the signals on the network link 1120 and through the communication interface 1118, which carry the digital data to and from the server 1130, are exemplary forms or carrier waves transporting the information.

In another embodiment of the server 1130, interface 1118 is connected to a network 1122 via a communication link 1120. For example, the communication interface 1118 may be an integrated services digital network (ISDN) card or a modem to provide a data communication connection to a corresponding type of telephone line, which can comprise part of the network link 1120. As another example, the communication interface 1118 may be a local area network (LAN) card to provide a data communication connection to a compatible LAN. Wireless links may also be implemented. In any such implementation, the communication interface 1118 sends and receives electrical electromagnetic or optical signals that carry digital data streams representing various types of information.

The network link 1120 typically provides data communication through one or more networks to other data devices. For example, the network link 1120 may provide a connection through the local network 1122 to a host computer 1124 or to data equipment operated by an Internet Service Provider (ISP). The ISP in turn provides data communication services through the Internet 1128. The local network 1122 and the Internet 1128 both use electrical, electromagnetic or optical signals that carry digital data streams. The signals through the various networks and the signals on the network link 1120 and through the communication interface 1118, which carry the digital data to and from the server 1130, are exemplary forms or carrier waves transporting the information.

The server 1130 can send/receive messages and data, including e-mail, program code, through the network, the network link 1120 and the communication interface 1118. Further, the communication interface 1118 can comprise a USB/Tuner and the network link 1120 may be an antenna or cable for connecting the server 1130 to a cable provider, satellite provider or other terrestrial transmission system for receiving messages, data and program code from another source.

The example versions of the embodiments described herein may be implemented as logical operations in a distributed processing system such as the system 1100 including the servers 1130. The logical operations of the embodiments may be implemented as a sequence of steps executing in the server 1130, and as interconnected machine modules within the system 1100. The implementation is a matter of choice and can depend on performance of the system 1100 implementing the embodiments. As such, the logical operations constituting said example versions of the embodiments are referred to for e.g., as operations, steps or modules.

Similar to a server 1130 described above, a client device 1101 can include a processor, memory, storage device, display, input device and communication interface (e.g., e-mail interface) for connecting the client device to the Internet 1128, the ISP, or LAN 1122, for communication with the servers 1130.

The system 1100 can further include computers (e.g., personal computers, computing nodes) 1105 operating in the same manner as client devices 1101, where a user can utilize one or more computers 1105 to manage data in the server 1130.

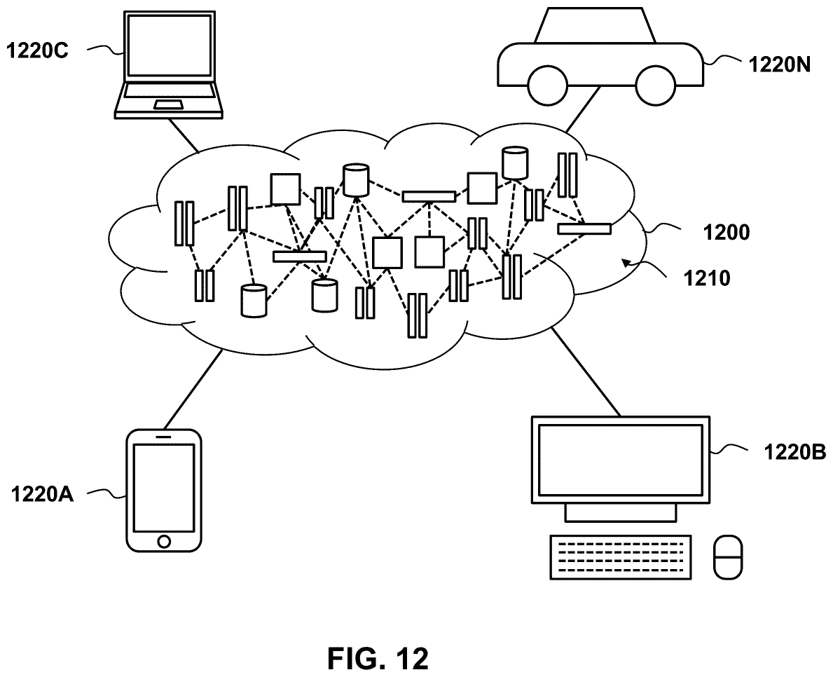

Referring now to FIG. 12, illustrative cloud computing environment 1200 is depicted. As shown, cloud computing environment 1200 comprises one or more cloud computing nodes 1210 with which local computing devices used by cloud consumers, such as, for example, personal digital assistant (PDA), smartphone, smart watch, set-top box, video game system, tablet, mobile computing device, or cellular telephone 1220A, desktop computer 1220B, laptop computer 1220C, and/or automobile computer system 1220N may communicate. Nodes 1210 may communicate with one another. They may be grouped (not shown) physically or virtually, in one or more networks, such as Private, Community, Public, or Hybrid clouds as described hereinabove, or a combination thereof. This allows cloud computing environment 1200 to offer infrastructure, platforms and/or software as services for which a cloud consumer does not need to maintain resources on a local computing device. It is understood that the types of computing devices 1220A-N shown in FIG. 10 are intended to be illustrative only and that computing nodes 1210 and cloud computing environment 1200 can communicate with any type of computerized device over any type of network and/or network addressable connection (e.g., using a web browser).

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further, it is intended that the scope of the present invention is herein disclosed by way of examples and should not be limited by the particular disclosed embodiments described above.

What is claimed is:

1. A system comprising:
a spine spanning from a tail portion to a nose portion of an aircraft, wherein the spine is configured to provide rigidity to the aircraft; and
one or more modules configured to be detachably attached to the spine, wherein the one or more modules are configured to be movable on the spine to obtain a desired center of gravity for the aircraft.

2. The system of claim 1, further comprising one or more spines spanning from the tail portion to the nose portion of the aircraft,
wherein the two or more spines are configured to be located at both sides of the aircraft.

3. The system of claim 1, wherein a position of each module of the one or more modules is configured to be movable on the spine to obtain a desired center of gravity for the aircraft.

4. The system of claim 1, further comprising: an active slid,
wherein the active slid is configured to receive a module arrangement instruction,
wherein the active slid is configured to automatically move each module of the one or more modules along the spine based on the received module arrangement instruction.

5. The system of claim 4, further comprising: a computing device including a processor,
wherein the processor is configured to receive weight information of each module of the one or more modules; and
wherein the processor is configured to generate the module arrangement instruction by calculating positions of the one or more modules to have a desired center of gravity for the aircraft based on the weight information.

6. The system of claim 5, wherein the one or more modules include the computing device.

7. The system of claim 1, wherein the one or more modules are configured to be detachably attached to the spine using at least one of: a sliding mechanism, an interlocking mechanism, screws, clamps, glue, and adhesive.

8. The system of claim 1, further comprising: a shell configured to cover the one or more modules,
wherein the shell is configured to provide access to the one or more modules disposed within the shell.

9. The system of claim 8, wherein the rigidity of the shell is less than the rigidity of the spine.

10. The system of claim 8, wherein the shell comprises a releasable closure mechanism, the releasable closure mechanism comprising:
an opening configured to be formed in a line shape along at least a portion of the shell; and
a closure configured to be formed along the opening, the closure configured to close the opening; and
wherein the releasable closure mechanism is configured to provide access to the one or more modules disposed within the shell.

11. The system of claim 8, wherein the releasable closure mechanism comprises at least one of: a zipper and a hook and loop fastener.

12. The system of claim 11, wherein the zipper is configured to be formed along a longitudinal direction of the shell.

13. The system of claim 1, wherein the nose portion of the aircraft is configured to receive a first end of the shell; and
wherein a rear portion of the aircraft is configured to receive a second end of the shell, wherein the first end is distal from the second end.

14. The system of claim 1, wherein positions of the one or more modules is configured to be adjusted based on different desired flight missions for the aircraft.

15. The system of claim 1, wherein the one or more modules include at least one of: a payload module, a power source module, a motor controller module, an avionics module, and a computing module.

16. A method comprising:
determining one or more modules needed for a flight plan of an aircraft;
detachably attaching the one or more modules to a spine of the aircraft; and
adjusting positions of the one or more modules to obtain a desired center of gravity for the aircraft.

17. The system of claim 16, wherein adjusting the positions of the one or more modules comprises:
receiving, by a processor in communication with the one or more modules and an active slid, weight information of each module of the one or more modules;
generating, by the processor, a module arrangement instruction by calculating positions of the one or more modules to have the desired center of gravity based on the weight information;
receiving, by the active slid, the module arrangement instruction from the processor; and
automatically moving, by the active slid, each module of the one or more modules along the spine based on the received module arrangement instruction.

18. The system of claim 17, wherein adjusting positions of the one or more modules is configured to be performed for flight conditions, and
wherein adjusting positions of the one or more modules is configured to be performed while the aircraft is in operation.

19. A method comprising:
securing at least one of: a power source and a payload to a spine of an aircraft;
positioning a shell over the at least one of: the power source and the payload; and
closing the shell to secure the shell between a nose portion and a rear portion of the aircraft.

20. The method of claim 19, wherein closing the shell is configured to be performed by closing a releasable closure mechanism, and
wherein the releasable closure mechanism comprises at least one of: a zipper and a hook and loop fastener.
